(19) United States
(12) Patent Application Publication
(10) Pub. No.: US 2003/0180603 A1
(43) Pub. Date: Sep. 25, 2003

(54) Power generation system having fuel cell modules

(76) Inventor: William R. Richards, Springfield, VA (US)

Correspondence Address: MATTINGLY, STANGER & MALUR, P.C., 1800 DIAGONAL ROAD, SUITE 370, ALEXANDRIA, VA, 22314, US

(21) Appl. No.: 10/393,919

(22) Filed: Mar. 24, 2003

Related U.S. Application Data
(60) Provisional application No. 60/366,256, filed on Mar. 22, 2002.
(60) Provisional application No. 60/366,257, filed on Mar. 22, 2002.

(51) Int. Cl. H01M 8/02; H01M 8/24

(52) U.S. Cl. 429/38; 429/39; 429/35

(57) ABSTRACT

A power generation system of fuel cells has modular fuel cell assemblies (modules) that are connected together in series. The modules each have independent ports for fuel and air connections. The fuel and air ports are connected to manifolds. A manifold on one module is connected to the manifold of an adjacent module using a low compression face seal at the connection. The manifolds have shape factors that provide controlled gas flow to enable Stoichiometric process uniformity among the respective series connected modules. Each module operates to generate power individually and the power connections for each module are also connected in series so that as more modules are connected together in series, the power generated by the system increases.

### BACKGROUND OF THE INVENTION

1. Field of the Invention

The present invention relates to fuel cells and in particular to a power generation system having fuel cell modules that are connectable in series.

2. Background

PEM fuel cells are used for power generation and each of the fuel cells has fuel and air requirements for operation. When a number of individual fuel cells are connected together to provide an increase in the power that is generated, problems develop with supplying the fuel and air with Stoichiometric uniformity among the respective modules.

In U.S. Pat. No. 6,030,718, a PEM fuel cell power system is disclosed that enables individual fuel cell modules to be connected to racks within a housing. The modules have a hydrogen distribution rack with a terminal end that engages a valve on the rack that supplies hydrogen gas to the module. The rack or housing has many slots and each slot accepts a module. Accordingly, there are valves for supplying hydrogen gas and a return for each slot.

The series combination of large numbers of fuel cell modules into a PEM fuel cell stack has generally resulted in performance degradation of individual fuel cell modules in the stack as compared with the individual performance for the module. This performance degradation phenomenon occurs as the number of fuel cell modules in the series increases.

### SUMMARY OF THE INVENTION

In order to develop a foundation for determining the possible reasons for observing the degradation in performance as the fuel cell stack increases in size, one would consider starting with analyzing the effect of connecting plural fuel cells in series, in general, and more specifically connecting fuel cell modules, each having fuel cells in a stack, together in series. The measured cell internal resistance typically shows values ranging from approximately 0.30 Ω-cm² to 0.70 Ω cm², at typical current densities ranging from 0.50 amps/cm² to 1.00 amps/cm². The resultant cell voltage loss ‘in circuit’ is therefore typically found to be ˜0.30 VDC loss per cell at its design current density (excluding the activation polarization voltage loss). The typical (average) Cell Internal Resistance magnitude is therefore found to be approximately 0.30 VDC/[0.30Ω-cm² to 0.70 Ω-cm²], or ˜0.70 Ω-cm²±0.30.

Another possible cause for excessively large values of performance degradation versus the number of cells in a series, is to evaluate the effects of Contact Voltage Drop between the cells that are placed in a series array. U.S. Pat. No. 5,547,777 discusses the function of applied compressive loading between adjacent conductive surface elements in proximate mechanical contact with one another. Higher compressive loads are shown to reduce this Contact Voltage Drop to some minimum value, generally independent of the type of material(s) in contact, from high (open circuit) values down to values approaching 0.0002 Ω, or 0.01 Ω-cm², as compressive load values are increased from no load to magnitudes of 150 Psig to 300 Psig. However, this Contact Voltage Drop Resistance magnitude is ˜70× less than that of the Cell Resistance magnitude, and therefore does not appear to be a likely candidate for explaining the degradation phenomenon previously described.

Insight may be gained towards identification of another possible contributing factor, by comparison of a PEM series of cells within a stack, to that of an equivalent set of batteries placed in series. A representative set of ‘D’ size alkaline batteries might typically have a measured Open Circuit Voltage of 1.58 VDC±0.02, and, four each placed in series with a 7.7 Ω electrical load resistance, would typically provide a total of 0.82 amperes at an output voltage of 1.38 VDC±0.02. The measured voltage loss of 0.2 VDC, divided by the measured current of 0.82 amperes, indicates a series resistance for the battery array of ˜0.24 Ω, or ˜0.06 Ω per battery at this load current. If it is further assumed that the effective active surface area within the battery is ˜12 cm², then the approximate Battery Internal Resistance equals 0.72 Ω-cm², and is therefore almost directly comparable to that of the PEM Cell Internal Resistance magnitudes previous identified. Conversely, the estimated series resistance due to Contact Voltage Drop increments occurring within a test lash up indicates a possible 0.005 Ω impact on the overall series resistance for the battery array or ˜2% of the total measured resistance, and a resultant variation of 0.001 VDC/battery. On possible conclusion therefore, is that the fundamental difference between the two cases comparing a PEM series of cells to that of an equivalent series of batteries is primarily due to the difference in the means of supply of electrochemical components needed to generate the electricity.

A battery uses a fixed, stored volume of reactants and a PEM fuel cell is supplied with these reactants from an external source. It is evident that variations in the means by which the reactants are supplied from an external source, are presently subject to far greater variations than that possible by setting a fixed, stored volume of reactants for generation of electricity, and this suggests that a highly controlled reactant supply capability for PEM cells in series arrays would yield similar capability, as presently exhibited by batteries placed in a series array. Instead of the typical ±0.020 VDC variations presently exhibited by the various embodiments of PEM fuel cell stacks, the capability therefore exists to theoretically achieve a minimum ±0.001 VDC variation in cell to cell output voltage, by achieving uniform supply of the reactant gases within the individual cells. In this manner, a high degree of load sharing capability can be achieved between the elements in a series array of cells as a result of the electro-chemical reaction(s) within each cell being uniformly accomplished.

According to the present invention, the reactant gasses are supplied through gas distribution passage elements that provide sufficient gas flow distribution capability at significantly reduced pressure loss per unit length, thereby yielding capability to achieve a very high degree of Stoichiometric process uniformity between the respective modules in a series array, at low supply pressures. Both fuel and reactant gas supply and return line pressures, and resultant internal pressure drops across the cells within a respective module, are thereby maintained at virtually identical operational states. The capability to achieve these virtually identical operational states provides the highest possible degree of Stoichiometric process uniformity between the respective modules, thereby yielding an optimal degree of load sharing capability between the modules connected in a series array. In addition, capability to achieve the desired output power levels at reduced supply pressures provides opportunity to select smaller, lower power consumption compressor assemblies, capable of delivering the required air flow volumes at the reduced supply pressures. Thus, overall fuel cell plant efficiency is achieved by reduction in gas transport parasitic losses.

The achievement of capability to realize a very high degree of load sharing uniformity between modules in a series array provides the basis for determining whether or not an array of smaller modules possessing ‘X’ kW output power capability can be efficiently connected in series to develop a higher increment of output power The gas distribution passage elements preferably have elongated slot gas distribution passages. Such passages are preferably incorporated within the individual cells of the fuel cell module itself, to control losses in velocity head (e.g., ΔP, psig=ρ*V²/2*g_{c}). These velocity head losses may be reduced by a factor of up to 16×, by providing the capability to reduce internal header velocities by a factor of up to 4×. This capability may be achieved without altering either the overall X and/or Y envelope dimensions of a typical PEM cell configuration. The variation in the magnitude of the velocity head losses ranges from a maximum value at a cell closest to the supply inlet port, where the gas flow velocities are greatest, to a minimum value at the cell furthest away from the same inlet. The converse holds for the variation in the magnitude of the velocity head losses for the return line outlet port. Stoichiometric uniformity is therefore can be closely maintained between the cells that are furthest apart within the stack envelope.

Additionally, the gas distribution passage elements having elongated slot distribution passages provide a capability to maintain laminar flow conditions at up to 433 increased gas flow volumes versus either circular or square passage alternatives. Finally, the associated pressure losses per unit length may be reduced by up to 32% by taking advantage of streamline versus turbulent flow processes, where the friction factor (f) for laminar flow at Reynolds Numbers (Re) 2000 equals 64/Re, yielding a factor of ˜0.032, and for turbulent flow equals 0.3164/Re^{0.25} yielding a factor of ˜0.047. Substitution of these friction factors into the Hagan-Poiseuille equation allows a determination of the pressure loss,

ΔP=f*L/D*ρ*V²/2g_{c}

for either the laminar or turbulent flow cases.

Finally, test results indicate capability to achieve a very high level of load sharing capability between cells within the same stack using gas distribution passage elements having elongated slot (in cross section) gas distribution passages. Measured performance results indicate less than ±3.5 mV variation in the measured output voltage between cells, whereas prior art techniques typically yielded variations of ±20 mV (or greater) between cells. A direct extrapolation to a series array of a 1-kW stacks, each consisting of 40 cells, and each capable of providing an output voltage of up to 25 VDC at 40 amperes, and using a single-ended supply similar in characteristic geometry to that embodied with the module itself, would provide a capability to achieve a maximum of only ±0.14 VDC variation between the respective modules within the series array, versus a minimum of ±0.80 VDC variation between modules if techniques of the known prior art were followed. Most significantly, the difference between the first and last modules in a single-ended distribution system, and/or either the first/last versus the mid-point module of a double-ended distribution system will be additive, such that incremental variations in output voltage would sum directly as the number of modules are increased. Therefore, the module located most remotely from the supply source would exhibit the highest level of degraded performance due to incipient flow starvation effects. This indicates that a series of 10 ea. modules would vary by ±1.4 VDC out of a nominal 25 VDC for the first versus the last module in the series array, if installed in a single-ended distribution system, and by 0.70 VDC if installed in a double-ended distribution system. Conversely, if prior art techniques were employed, variations of ±8.0 VDC for single-ended systems and ±4.0 VDC for double-ended systems would result. A cursory inspection of these extrapolated voltage fluctuation magnitudes therefore provides support for discerning why series array configurations of smaller-sized standardized building-block modules have not previously been successful.

In the development of fuel cell stack designs with large active areas and/or increased numbers of cells, performance penalties that are not readily apparent, nor fully understood are encountered. Employment of larger active areas implies that the cells will be proportionately affected by the phenomenon of localized hot-spot generation. Hot spot generation induces membrane failures and/or degradation either due to plastic creep, loss of tensile or compressive stress capability, and/or to the partial gelatin of the membrane material to allow catalyst blooming (agglomeration or clumping of Pt. catalyst resulting in a direct reduction to the effective surface area of the electrode structure) and results in a direct performance degradation. The increased active areas are also more subject to anomalous gas transport effects over the proportionately increased area, as exhibited by localized variations in membrane hydration state, water beading and/or flooding, gas over supply and/or starvation, etc., etc. These problems are proportionately magnified by design solutions which simply employ an increased number of cells within a stack, and strongly suggests why both stack reliability and operational performance capabilities are far below theoretical expectations. A fuel cell stack is only as reliable at its weakest link, and failure of a single cell within a multicell stack causes the stack to become immediately inoperable. It is therefore apparent that a series array of smaller-sized fuel cell stacks should possess higher performance capability, and provide a greater operational reliability than a single larger-sized fuel cell stack. The failure of a single cell within one of a multiplicity of modules in a series array only reduces the output power by a factor of 1/Number of Modules and permits the overall fuel cell power generation module to remain in operation without interruption of the supplied power. Employment of a single larger-sized module, on the other hand, results in a complete shutdown for a single cell failure.

The following example will be used to illustrate the above characteristics: A PEM fuel cell stack is considered which provides 1-kW at nominal 25 VDC and 40 amperes (0.8 amps/cm²), consisting of 40 cells, and having an active area of 50 cm² for each cell. The stack typically operates at 1.433 Stoichiometric demand rate (Q, in³/sec.) for the air supply. Therefore, based upon a theoretical consumption rate for oxygen of ˜3.5 cm³ per minute per ampere per cell, or 0.00355 in³/sec. per ampere per cell, the air volume at a ˜20% concentration of oxygen equals 0.0178 in³/sec per ampere per cell, times the 1.433 adjustment factor for Stoichiometric requirements, yielding a value of ˜0.025 in³/sec. per ampere per cell. This value of ˜0.025 in³/sec. times the number of cells (40 ea.) and also times the number of amperes (40 ea) yields a value of ˜40 in³/sec., or 1 in³/sec. per cell for the 1-kW stack, and noting also, that the measured internal pressure drop across the fuel cell stack is 0.25 Psig. Once the flow rate is determined, the Reynolds Number (Re) may then be calculated using the relationship

ρ*V*D/μ,

where ρ˜1.05×10⁻⁵#-sec²/in⁴, and μ˜3.26×10⁻⁹ #-sec/in², or, by direct substitution, Re=32.2*V*D.

Re must be kept to a value of 2000 in order for laminar flow conditions to exist, which indicates that the product V*D must be 62.1. The ‘D’ term is the hydraulic diameter for symmetric passageways and/or the hydraulic radius (or characteristic dimension) for non-symmetric passageways, and the air flow velocity (V, in/sec.) is equal to Q, in³/sec/flow passage area (A, in²). The required diameter for a circular flow passage would therefore equal ˜0.82 inch, and yield an average flow velocity of ˜75.74 in/sec. at the required 40 in³/sec. air flow volume. Conversely, an elongated slot of identical cross-sectional area, at ˜0.23 in. wide X˜2.3 in. long, would possess a Hydraulic Diameter (4×Area/Wetted Perimeter) of ˜0.46 inch, or a Hydraulic Radius of ˜0.23 inch, at an air flow velocity of ˜75.74 in/sec., and yield a Re of ˜560 for the same air flow volume. A comparison between these two alternatives indicates that gas distribution passage elements with elongated slot gas distribution passages provide significant advantage over that of an equivalent passage of either round or square cross section, and thereby provides a more optimized shape factor for gas transport between modules, and within the module itself.

The maximum allowable sizing of these slotted distribution passages may be determined by: (1). Recognizing that the gas distribution passages are typically arrayed within a fuel cell stack in a perimeter (non-active) area about the active area of the cell; (2). Recognizing that it is highly desirable that the relative area of the non-active areas versus that of the active area is minimized, such that the overall fuel cell stack envelope and weight and associated costs related to the increased size of cells is also reduced; and (3). Recognizing that it is highly desirable that the fuel cell stack clamping mechanism features are included in this consideration of non-active area perimeter sizing on overall envelope and weight. An optimal configuration is therefore suggested which allows the designer to minimize this perimeter region to the smallest practical area, yet allow for the greatest possible air flow distribution capability within this same perimeter region. Based upon the above considerations, it is possible to conclude that the maximum allowable slot dimensions are established by constraints of the centerline spacing interval(s) between the clamping elements (tie-rods or other), the clamping feature size or diameter, and the allocation of space to accommodate gas sealing features for the respective gas distribution passages. Per the example, the cell has an active area region of 50 cm² (˜2.31 inch X˜3.38 inch) and uses 0.25 inch diameter tie-rods located at a spacing separation interval of 3.00 inch X 3.50 inch. Based upon these parameters, a maximum allowable slot dimension may be determined, and equals ˜0.25 inch X˜2.5 inch, with a useable gas flow area of ˜0.625 in². For gas distribution passage elements according to the present invention having a slot shaped passage, the maximum cross sectional area achieved by the slot shape can provide up to a 433 increase in the total air flow volume for the same Re of 2000, as compared to an equivalent 0.82 inch diameter hole with useable flow area of 0.528 in². Gas velocities are therefore kept to a minimum, and low velocity head and frictional losses result.

An additional advantage of employing the gas distribution passage elements of the present invention can be achieved by also reducing the cross-sectional area of the fuel cell stack as compared to prior art designs. The perimeter area of the cell could be reduced from a nominal 1.00 inch chord thickness to accommodate gas distribution passage elements having feature sizes of 0.82 inch., to 0.50 inch chord thickness as a result of incorporating the slot shaped cross sectional gas distribution passage elements, and therefore a net reduction in the envelope of the fuel cell stack can be achieved, for example, from a nominal ˜4.31 inch X˜5.38 inch size to a˜3.31 inch X˜4.38 inch size, or, yielding a net reduction of 37.5% in both envelope and weight, and in a proportional reduction in the associated manufacturing cost.

The impact on overall system efficiency for an individual fuel cell stack module, or for a series array of modules may be further quantified by consideration of an off-the-shelf high speed vane compressor assembly operating at ˜50% efficiency, and capable of providing 40 in³/sec (e.g., 1.38 SCFM) at a supply pressure of 1.5 Psig, and with a power consumption of 72 watts. This power level is ˜7.2% of the total output capacity of the fuel cell stack. Conversely, consideration of stack operation at 5 Psig or higher supply pressures, would require a proportionate increase in the power consumption to 240 watts, or ˜24% of the total output capacity of the fuel cell stack. As is evident, a point of diminishing returns is approached very rapidly. The ability to operate a series array of fuel cell modules efficiently is highly sensitive to the performance characteristics of the gas distribution system design approach selected for connecting the respective modules together.

According to the invention, integration of external gas distribution passage elements having slot shaped passages, for example embodied by gas distribution manifold assemblies is therefore highly desirable,. These external gas distribution passage elements having slot shaped passages may be readily incorporated within the existing form factor(s) allocation for installation of supply and return lines, as previously established by use of the prior art techniques, yet provides capability to realize a minimum 433 increase to the air flow volumes transported within the optimized gas distribution system.

Preferably, according to the invention, a power generation system has fuel cell modules of at least three cells each that are integrated and configured to support building-block construction of stacks of the fuel cell modules. Further, the modules preferably facilitate direct attachment of the external manifold elements to the individual modules, such that both fuel and reactant gas distribution supply and return features for series and/or parallel configuration may be achieved. These external manifold elements should preferably incorporate gas sealing features such as face-seal glands for effecting positive (bubble or leak-tight) connection with integrity of both the individual module and of the series array of modules, and provide the requisite flow passage geometry (cross-sectional area and length to effect a series connectivity between the fuel and reactant gas inlet and outlet ports of the respective modules, without the need or use of any metallic fittings. In addition, they should be preferably be amenable to being manufactured from light weight, non-conductive plastic materials using high speed injection molding or similar production techniques. Finally, they should preferably provide capability for integration of failsafe isolation valving for the fuel and reactant gases supply and return lines.

The resultant series array configuration provides means to realize an exceptionally efficient, high power density power generation array concept, capable of being readily modified to incorporate up to 15 ea. 5-kW modules in series or up to 15 ea. 1-kW modules in series.

### BRIEF DESCRIPTION OF THE DRAWINGS

FIG. 1 is a perspective view of a stackable PEM fuel cell building-block module mounted to a subplate manifold according to the present invention. Fuel and reactant gas supply lines are shown connected to the back side of the subplate manifold, and a set of external manifold blocks are shown for making connection from the respective fuel and reactant gas distribution lines within the subplate manifold to the desired inlet and outlet ports located on the external faces of the 5-kW module.

FIG. 2 is a perspective view of the stackable PEM fuel cell building-block module depicted in FIG. 1, illustrating the means by which a second module may be aligned, stacked, and electrically connected on top of the first module. The external manifold blocks are shown providing a continuous passage for the transport of either the fuel or reactant gases between the respective modules connected in series.

FIG. 3 is an exploded perspective view perspective view of the stackable PEM fuel cell building-block module depict in both FIGS. 1 and 2, illustrating the means by which double-ended gas feed ports are provided for both the fuel and reactant gas external manifold blocks, for connection to upper and lower end plate subassemblies.

FIG. 4 is an exploded perspective view 3-D of the inside portions of the PEM fuel cell building-block module depicted in FIGS. 1, 2, and 3. FIG. 5A is a top view of a modified gas distribution end plate within the fuel cell module which has slot shaped (in cross section) gas distribution passages.

FIGS. 5B and 5C are partial cross sectional views of FIG. 5A, taken along lines A-A and B-B, respectively.

FIG. 6 is a top view of the PEM fuel cell building-block module depicted in FIG. 5, with external manifold blocks having slot shaped (in cross section) gas distribution passages.

FIG. 7 is partial sectional view of the PEM fuel cell building-block module according to FIG. 6, taken along line C-C.

### DETAILED DESCRIPTION OF THE DRAWINGS

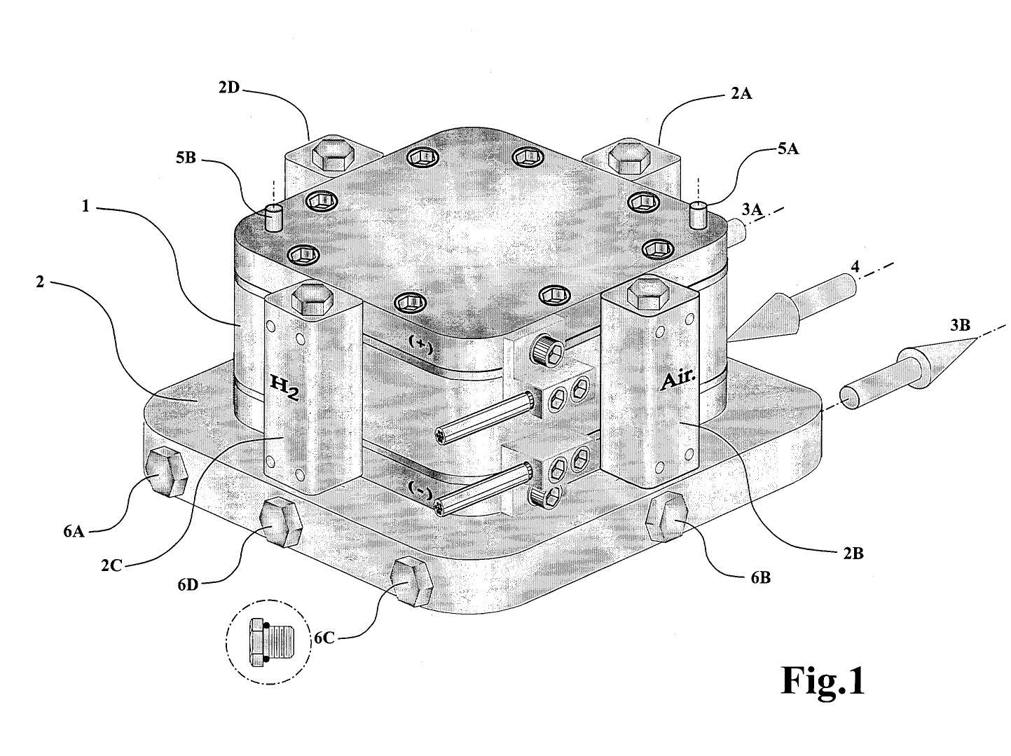

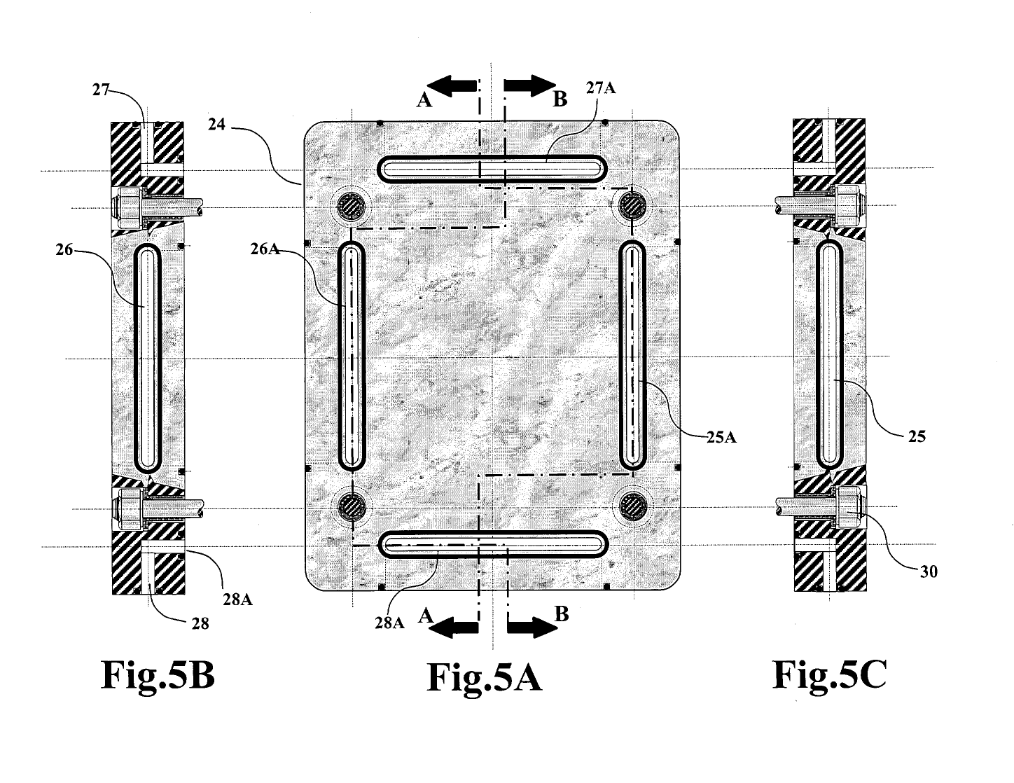

FIG. 1 is a perspective view of a stackable PEM fuel cell building-block module 1 mounted to a subplate manifold 2. Preferably, for purposes of illustration and discussion, the PEM fuel cell module of FIG. 1 is a 5 kW module, however, the size can be that of a 1 kW module, which is preferably the size of the module shown in FIGS. 5-7. Fuel supply line 4 and reactant gas supply and return lines 3a and 3b are shown connected to the back side of the subplate manifold. A set of non-conductive external manifold blocks 2a, 2b, 2c and 2d are shown as making connection from the respective fuel and reactant gas distribution lines port locations located on the top face of the subplate manifold, to the desired inlet and outlet ports locations on the external faces of the module. Alignment pins 5a and 5b provide mounting alignment features for stacking of one PEM fuel cell building-block module upon another module. SAE O-ring Port Plugs 6a, 6b, 6c, and 6d are shown as effecting sealing of the internal machined passageways by direct mounting onto the accessible vertical surfaces on the subplate manifold.

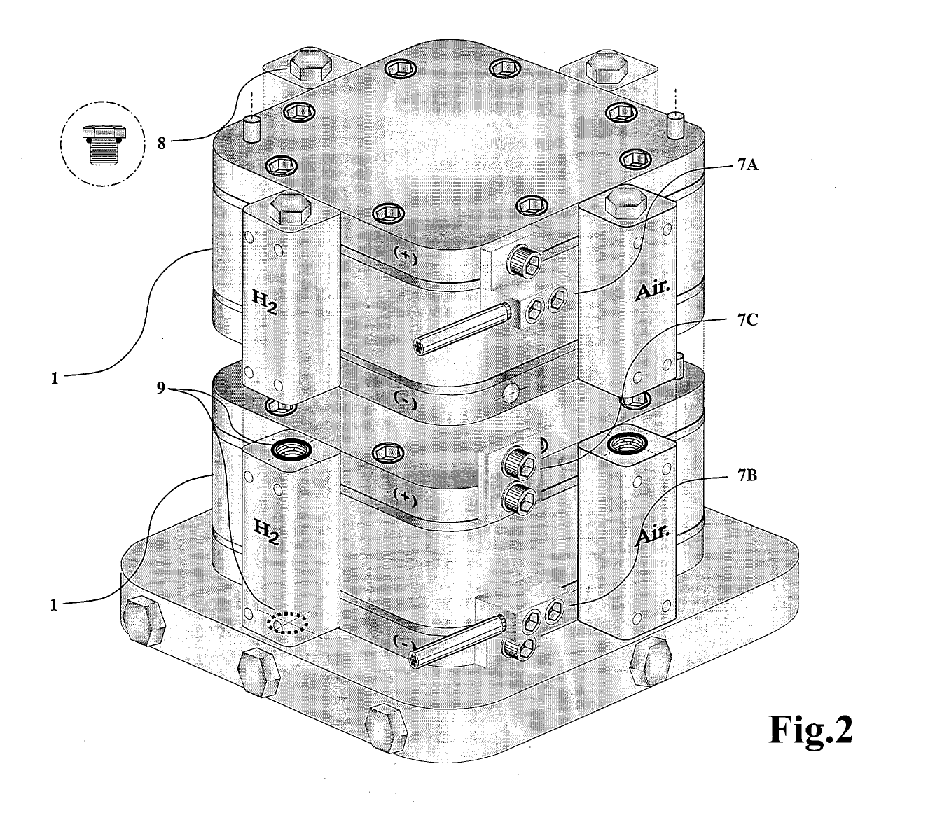

The fuel cell module is designed as a building block module that can be stacked in a vertical stack with connectors or clamps securing adjacent modules to one another. FIG. 2 is a perspective view of the stackable PEM fuel cell building-block module 1 depicted in FIG. 1, illustrating that a second module 1 may be aligned using the alignment pins 5a and 5b previously described, stacked, and electrically connected using an intermediate buss clip 7c to effect electrical continuity between the upper and the lower modules 1. A total of up to fifteen modules or more may be stacked in series by this technique. The remainder of the electrical connections features for tying into an external load is provided by the upper and lower buss clamps 7a and 7b. The non-conductive external manifold blocks are shown to provide a continuous passage for the transport of either the fuel or reactant gases between the respective modules connected in series., The external manifolds have face-seal O-ring gland 9 at both ends thereof. The overall path length for a nominal stack of five modules would be approximately 2 feet, wherein 0.375″ diameter internal passageways would yield an approximate 0.50 Psig pressure drop, and 0.625″ diameter passageways would yield an approximate 0.04 Psig pressure drops over the total length of the stacked external manifold blocks elements. These external manifold blocks provide mounting interface features to permit leak tight intermediate connectivity or endpoint termination capability by use of SAE O-ring Port Plugs or similar.

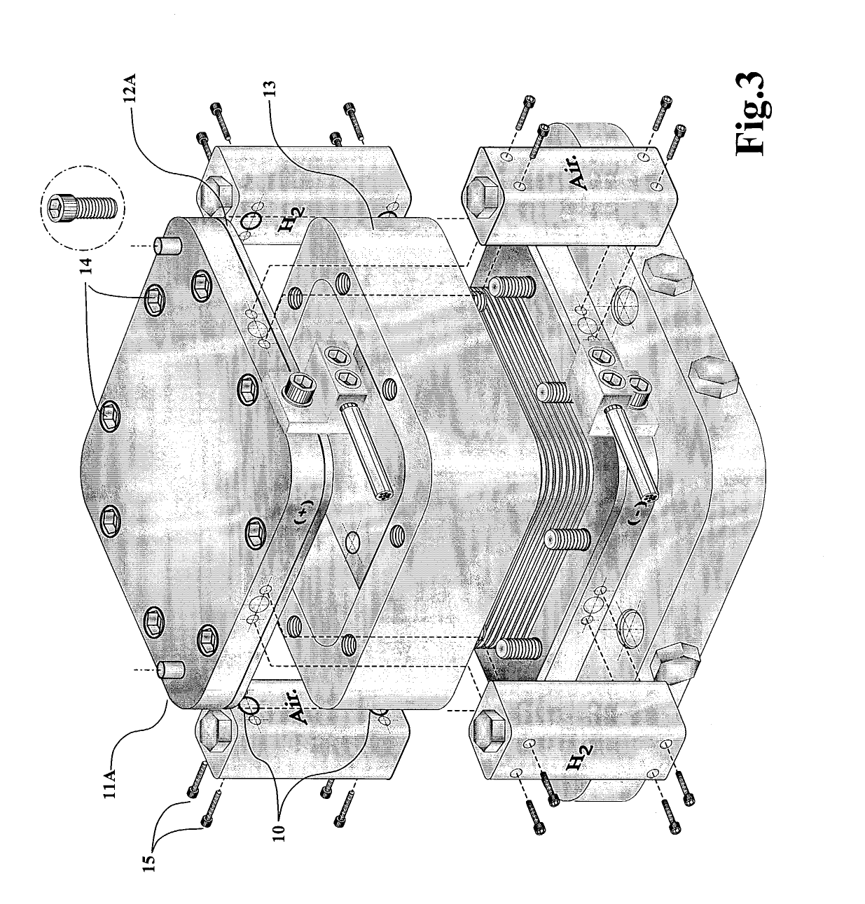

FIG. 3 is a perspective view (exploded view) of the stackable PEM fuel cell building-block module depicted in both FIGS. 1 and 2, illustrating the double-ended gas feed ports 10 that are provided for both the fuel and reactant gas external manifold blocks 2a, 2b, 2c, and 2d, for connection to upper and lower end plate subassemblies 11a and 11b. These external manifold blocks are attached to the end plate subassemblies by threaded fasteners 15 These end plate subassemblies functionally provide the gas transport passageways for connection to the respective fuel and reactant gas distribution headers for the stack of cells within the fuel cell module. The end plate assemblies in combination with the housing 13 effect an appropriate level of compressive preloading to the active area of approximately 250 Psig×the active area of 250 cm² or approximately 5 tons clamping force to the set of cells within the fuel cell module by the set of threaded fasteners 14. The current collection 7a and 7b is also achieved through the end plates. These plates are depicted as using gasket sealing 12a and 12b with the non-conductive housing subassembly 13 to allow positive pressurization above that of the fuel and reactant gas supplies, such that leak-tight integrity of the fuel cell stack is maintained. The exposed leakage path length equals the number of cells times two gaskets×the gasket perimeter@<7.75 inches×7.75 inches square, or 31 inches, or over ˜100 feet for the fuel gas leakage path and ˜100 feet for the reactant gas leakage path, at the respective internal supply pressures required for stack operation.

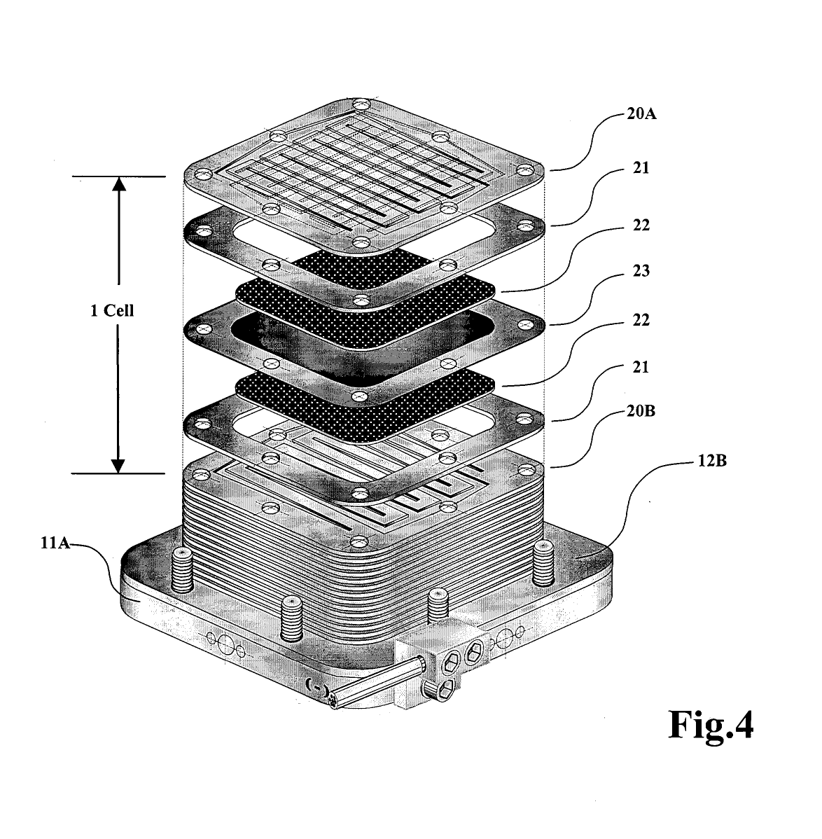

FIG. 4 is a perspective view (exploded view) of the inside portions of a PEM fuel cell building-block module 1 depicted in FIGS. 1, 2, and 3. This illustration depicts both an alignment pin hole pattern, located at the corners of the individual cell component elements, and a fuel and reactant gas distribution hole pattern located at midpoints between that of the alignment pin pattern. The figure depicts a view of 1 of the 40 cells utilized to generate a nominal 5-kW of output power 25 VDC at 200 amperes. A single cell's overall thickness regardless of the size of the active area chosen for the design is approximately 0.080 inches, with an active area (darkened center portion of item number 23) of approximately 250 cm². An individual cell consists of an upper anode fuel gas distribution pattern as depicted in phantom dotted line on the bi-polar plate item 20a and a lower cathode reactant gas distribution pattern on the lower bi-polar plate 20b positioned at right angles to that of the fuel gas distribution pattern. Sandwiched between these two plates are a membrane electrode assembly (MEA) 23, which is itself sandwiched between a set of rigid non-conductive gaskets 21 with associated gas diffusion media (GDM) 22.

FIG. 5 is a top face illustration of the gas distribution passages of the end plate according to a modification of the embodiment shown in FIG. 1. Whereas circular gas distribution passages are shown in the FIG. 1 embodiment, in this embodiment, the gas distribution passages 25a, 26a, 27a and 28a that are slot shaped in cross section. The slots are rectangular in overall shape with rounded end portions that are approximately semicircular. Preferably, the rectangular dimensions are 4 to 1˜10 to 1 in length to width dimensions with semicircular end portions that have a diameter equal to the width dimension. An actual rectangular shape can also be used, but this makes it difficult to provide an O ring seal. Accordingly, a seal appropriate for a rectangle would be required. Further, the right angle corners of the flow passage at the corners of an actual rectangle might also have a deleterious effect on air gas flow, so the rounded corners are desired. In this respect a flattened ellipsoid cross sectional shape is also possible to use since it provides the same flow volume considerations within the shape factor that are sought in accordance with the teachings of the invention and enabling an O ring seal interface. However, this cross sectional shape is potential difficult to manufacture, which makes it less preferable than the rectangular shape having semicircular end portions.

The fuel cell has an external dimension or envelope that includes the set of end plate assemblies and the module of FIG. 5 depicts a preferred embodiment of a nominal 1-kW PEM fuel cell building-block module. The slotted gas distribution passages 25a, 26a, 27a and 28a provide maximum gas flow volumes within a minimum shape factor, that are clearly more space efficient than circular or square cross-sectional shaped passages. Fuel and Reactant gas feed ports for making the respective supply and return connections 25, 26, 27, and 28, and provides the preferable features for minimizing velocity head losses as would normally occur for discontinuous flow area changes across external feed lines and internal ports/distribution passages. The area ratio and shape factors are kept identical between ports 25 and 25a, 26 and 26a, 27 and 27a, and 28 and 28a. Insulated tierod assemblies 30 are located as close as physically possible within the actual envelope of the cells non-active, or gasketed, region to the active area of the cell, to allow the highest possible clamping pressures to be uniformly applied over the active region. This uniformity in clamping stresses is accomplished by keeping the spacing interval between the tierods to the lowest possible value, by utilizing end plate material thickness and associated material mechanical properties to minimize bending/deformation variations over the active region of the cell. The minimum required level of clamping forces for a nominal 50 cm² active area is approximately 250 Psig±50, or requires approximately 2000# clamping force, or approximately 500 # of clamping force per tierod assembly.

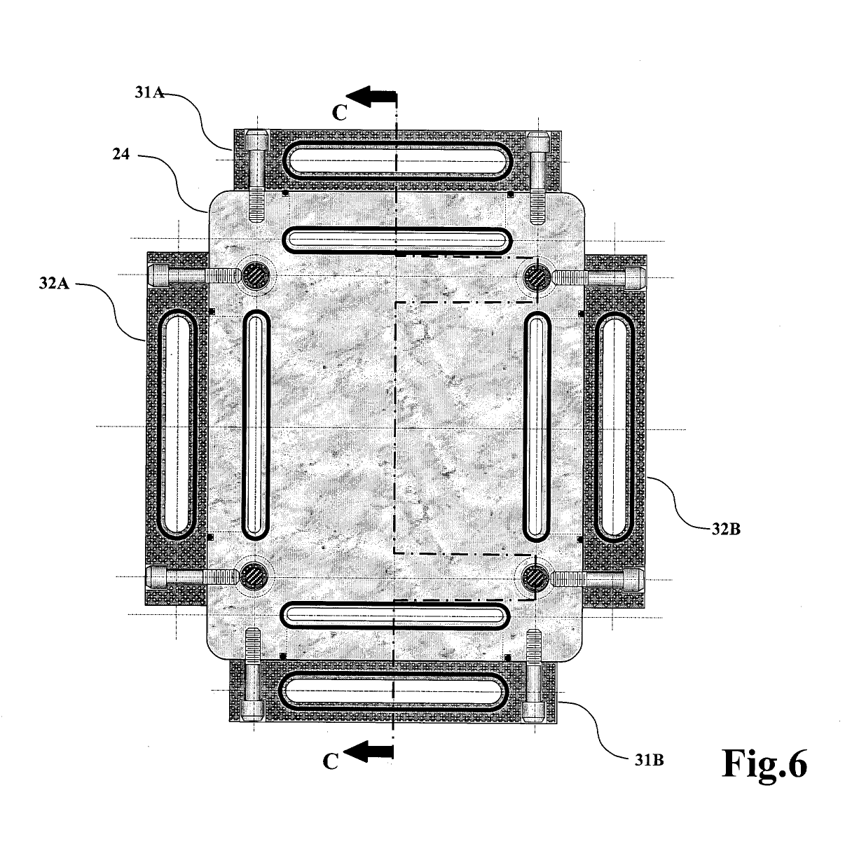

FIG. 6 is a top view of the fuel cell module according to FIG. 5 further illustrating a set of non-conducting external manifold blocks 31a, 31b, 32a and 32b that having similarly slotted shaped passages.

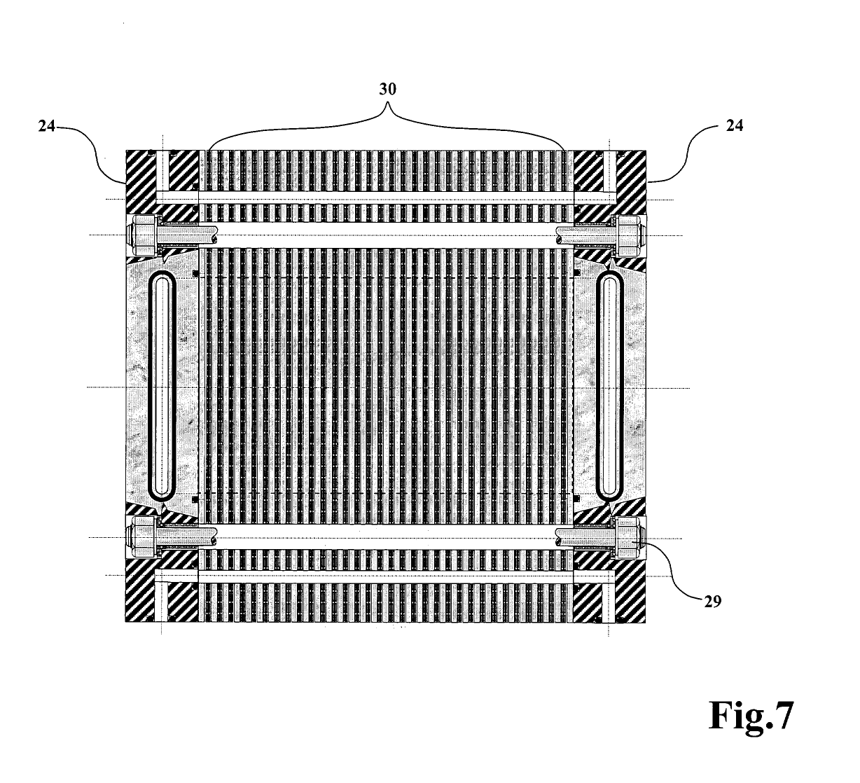

FIG. 7 is a sectional view of the fell cell module of FIG. 6 taken along line C-C in FIG. 6. The double-ended supply configuration shown in FIG. 3 is shown in detail in FIG. 7. The manifolds are preferably constructed of an electrically insulated material, such as a plastic material.

According to the present invention, a uniform supply inlet and/or outlet return pressure drop conditions for the establishment of Stoichiometric process uniformity between cells within a fuel cell stack, and between fuel cell stack building-block modules within a series array, regardless of their proximity to the supply lines connected to the subplate manifold.

Further, according to the present invention, fuel cell module incorporates optimized shape factor gas feed slots as alternatives to circular hole distribution header/port features, to realize significantly increased volumetric flow capacity, reduced fuel cell stack envelope and weight, increased overall plant efficiency, and minimized variation in load sharing between cells within a module, and between modules in a series array. The employment of slots versus circular hole features facilitates the realization of cell elements possessing the largest possible gas flow delivery volumes with the least pressure drop, yet requiring no additional peripheral area of the cell for allocation of both fuel and reactant gas feed supply and return features. Virtually the entire peripheral area framing the active area of the cell is utilized to accomplish the function of fuel or reactant gas distribution. The result of incorporation of the resultant slotted versus circular gas feed distribution features provides greatly reduced gas flow velocities, and associated pressure gradients between cells within the module, yet does not affect either the X or Y dimensions of the desired cell geometry.

The main gas distribution headers that are usually provided within the stack envelope are moved in location to outside the stack envelope, such that these external distribution headers may be appropriately sized to realize laminar flow conditions at gas flow volumetric rates many times greater than that required for a single building-block module. This further facilitates the achievement of a uniform supply inlet and/or outlet return pressure drop condition for any of the building-block modules within the stack.

Also, according to the invention, these external manifold elements are constructed of modular building block design and are capable of being manufactured using low cost injection-molded plastic or similar non-conductive material, The integral face-seal gland features replace the prior art techniques of employing threaded gas fittings for effecting both fuel and reactant gas connections to the fuel cell stack. Thus, a three-dimensional manifold element assembly results from the use of the external manifold elements for both fuel and reactant gas supply, and thereby a series array of cells are enclosed within a module as a continuous housing feature. Employment of such a continuous housing feature, with integral slotted passage gas distribution manifold(s) provides both an explosion-proof containment system and a high gas flow capacity gas distribution system as a single structural element.

As is readily apparent, the fuel cell power generation system of the present invention uses fuel cell modules that are easily remove and/or replaced in a building block arrangement in which individual building-block modules are connected together in series connection.

Further design modifications are also contemplated by the present invention, including failsafe isolation poppet valves, cartridge insert type or similar, into all of the inlet and outlet ports of the external gas distribution modules , which thereby allows for the isolation of said the associated fuel cell module in the event of a thermal overload, and which thereby allows for the continued operation of other building-block modules within the fuel cell stack itself.

Although particular embodiments have been described, various modifications will become apparent to one of ordinary skill in the art upon reading and understanding the foregoing description. All such modifications that basically rely upon the teaching through which the present invention has advanced the state of the art are properly considered within the spirit and scope of the invention.

I claim:

1. A fuel cell power generation system, comprising:
series connectable modular assemblies, each of said modular assemblies including a power generation module having end plates and at least three cells between said end plates;
each of said modules having ports in said end plates and internal passages connected to the ports for low velocity gas flow in supply and return passages providing uniform supply of fuel and reactant gases to said cells with resultant Stoichiometric process uniformity of the gases occurring over the electro-chemically active regions within each said cell for each of said modules;
first and second, non-conductive manifolds connected to said ports in said end plates of said module for effecting low velocity gas distribution between adjacent ones of said modules connected in a series array,
said first and second external, non-conductive manifolds each having an inline inlet and outlet port at opposite ends capable of being sealed by use of a low-compression face-seal thereby allowing for end to end connectivity and sealing of gas supply and return passages from module to module, said outlet port also accommodating installation of a port plug when said outlet port is in a terminal one of said first and second manifolds at one end of a series connected array of said modules; and
said of said end plates having said ports for double-ended supply and/or return to each of said modules through said first and second manifolds.

2. A fuel cell power generation system according to claim 1, wherein said first and second external, non-conductive manifolds are fabricated identical in length to that of the respective individual power generation module height, as determined by the distance between a top face of an upper one of said end plates to a bottom face of a lower one of said end plates, with alignment and mechanical coupling of modules in series thereby effecting a resultant compression and subsequent sealing of said end to end connections between said manifolds.

3. A fuel cell power generation system according to claim 1, wherein said first and second external, nonconductive manifolds deliver the fuel and reactant gasses with low pressure drop, at initial supply pressures at or below 5 Psig to 1.5 Psig.

4. A fuel cell power generation system according to claim 1, wherein said first and second external, non-conductive manifolds have internal passages having a same dimension and shape in cross section as said internal passages and said passages of said end plates.

5. A fuel cell power generation system according to claim 1, wherein said internal passages and of said passages of said first and second external, non-conductive manifolds have a generally rectangular cross sectional shape that has a length to width dimension form 4 to 1 to 10 to 1 to deliver the fuel and reactant gasses with low pressure drop

6. A fuel cell power generation system according to claim 5, wherein said internal passages and said passages of said manifolds have a cross sectional shape that includes rounded end portions that are approximately semicircular and have a diameter that is equal to the width dimension.

7. A fuel cell modular assemblies, comprising:
opposed end plates and at least three cells between said end plates;
ports in said end plates and internal passages connected to the ports for low velocity gas flow in supply and return passages providing uniform supply of fuel and reactant gases to said cells with resultant Stoichiometric process uniformity of the gases occurring over the electro-chemically active regions within each said cell;
first and second, non-conductive manifolds connected to said ports in said end plates for effecting low velocity gas distribution, said manifolds having passages that have a same cross sectional shape and dimension as said internal passages of said cells;
said non-conductive manifolds each having an inline inlet and outlet port at opposite ends capable of being sealed by use of a low-compression face-seal thereby allowing for end to end connectivity and sealing of gas supply and return passages between adjacent manifolds that are connected together to form a series array of modules, said outlet port also accommodating installation of a port plug when said outlet port is in a terminal one of said manifolds at one end of a series connected array of said modules; and
said of said end plates having said ports for double-ended supply and/or return to each of said modules through said first and second manifolds.

8. A fuel cell power generation system according to claim 7, wherein said first and second external, non-conductive manifolds are fabricated identical in length to that of the respective individual power generation module height, as determined by the distance between a top face of an upper one of said end plates to a bottom face of a lower one of said end plates, with alignment and mechanical coupling of modules in series thereby effecting a resultant compression and subsequent sealing of said end to end connections between said manifolds.

9. A fuel cell power generation system according to claim 7, wherein said internal passages and said passages of said first and second external, non-conductive manifolds have a generally rectangular cross sectional shape that has a length to width dimension form 4 to 1 to 10 to 1 to deliver the fuel and reactant gasses with low pressure drop

10. A fuel cell power generation system according to claim 9, wherein rectangular cross sectional shape has rounded end portions that are approximately semicircular and have a diameter that is equal to the width dimension.
